(19) United States
(12) Patent Application Publication
(10) Pub. No.: US 2008/0157313 A1
(43) Pub. Date: Jul. 3, 2008

(54) Array capacitor for decoupling multiple voltages

(76) Inventors: Sriram Dattaguru, Chandler, AZ (US); Mahadevan Suryakumar, Gilbert, AZ (US); Thomas S. Dory, Gilbert, AZ (US)

Correspondence Address: INTEL CORPORATION;c/o INTELLEVATE, LLC, P.O. BOX 52050, MINNEAPOLIS, MN, 55402, US

(21) Appl. No.: 11/648,215

(22) Filed: Dec. 29, 2006

(51) Int. Cl. H01G 4/35; H01G 4/40

(52) U.S. Cl. 257/678; 361/306.2; 361/683; 361/811

(57) ABSTRACT

In some embodiments, an array capacitor for decoupling multiple voltages is presented. In this regard, an array capacitor is introduced having two electrically isolated capacitor regions. Other embodiments are also disclosed and claimed.

### FIELD OF THE INVENTION

Embodiments of the present invention generally relate to the field of integrated circuit packages, and, more particularly to an array capacitor for decoupling multiple voltages.

### BACKGROUND OF THE INVENTION

Array capacitors are being attached to, or embedded in, the substrates of high frequency integrated circuit packages to manage power delivery to the die(s). Additionally, traditional array capacitors provide a single fixed capacitance for decoupling a single voltage.

### BRIEF DESCRIPTION OF THE DRAWINGS

The present invention is illustrated by way of example and not limitation in the figures of the accompanying drawings in which like references indicate similar elements, and in which:

FIG. 1 is a graphical illustration of a cross-sectional view of an array capacitor for decoupling multiple voltages, in accordance with one example embodiment of the invention;

FIG. 2 is a graphical illustration of a cross-sectional view of an array capacitor for decoupling multiple voltages, in accordance with one example embodiment of the invention;

FIG. 3 is a graphical illustration of an overhead view of an array capacitor for decoupling multiple voltages, in accordance with one example embodiment of the invention;

FIG. 4 is a graphical illustration of a cross-sectional view of an IC package including an attached array capacitor for decoupling multiple voltages, in accordance with one example embodiment of the invention; and

FIG. 5 is a graphical illustration of a cross-sectional view of an IC package including an embedded array capacitor for decoupling multiple voltages, in accordance with one example embodiment of the invention; and

FIG. 6 is a block diagram of an example electronic appliance suitable for implementing an IC package including an array capacitor for decoupling multiple voltages, in accordance with one example embodiment of the invention.

### DETAILED DESCRIPTION

In the following description, for purposes of explanation, numerous specific details are set forth in order to provide a thorough understanding of the invention. It will be apparent, however, to one skilled in the art that embodiments of the invention can be practiced without these specific details. In other instances, structures and devices are shown in block diagram form in order to avoid obscuring the invention.

Reference throughout this specification to “one embodiment” or “an embodiment” means that a particular feature, structure or characteristic described in connection with the embodiment is included in at least one embodiment of the present invention. Thus, appearances of the phrases “in one embodiment” or “in an embodiment” in various places throughout this specification are not necessarily all referring to the same embodiment. Furthermore, the particular features, structures or characteristics may be combined in any suitable manner in one or more embodiments.

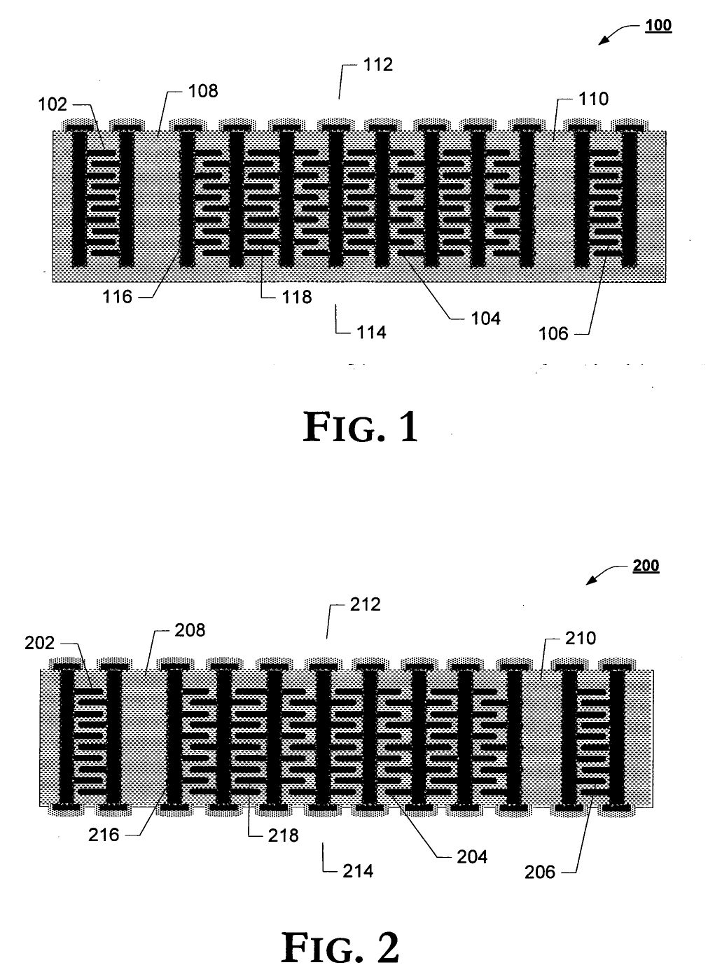

FIG. 1 is a graphical illustration of a cross-sectional view of an array capacitor for decoupling multiple voltages, in accordance with one example embodiment of the invention. In accordance with the illustrated example embodiment, array capacitor 100 includes one or more of first capacitor region 102, second capacitor region 104, third capacitor region 106, bridge regions 108 and 110, top surface 112, bottom surface 114, vertical vias 116 and capacitor plates 118.

While shown as including three electrically isolated capacitor regions, array capacitor 100 may include any number of unique capacitor regions which may or may not have the same capacitance values. In one embodiment, capacitor regions 102 and 106 have capacitance values of about 2 microfarads, while capacitor region 104 has a capacitance value of about 40 microfarads. In another embodiment, capacitor regions 102 and 106 are designed to provide decoupling to an I/O source voltage, while capacitor region 104 is designed to provide decoupling to a core (or common collector) voltage.

Bridge regions 108 and 110 electrically isolate and reduce crosstalk between capacitor regions 102, 104, and 106. Bridge regions 108 and 110 can be made of ceramic or other dielectric material. One skilled in the art would appreciate that the unique capacitor regions shown in array capacitor 100 can provide decoupling for multiple voltages.

Top surface 112 contains bumps or other conductive elements through which array capacitor 100 may be coupled with other components, for example a substrate. In one embodiment, bumps on top surface 112 are coated with nickel and tin to enable soldering to a substrate. As shown, vertical vias 116 carry current from top surface 112 to capacitor plates 118, which store charge.

FIG. 2 is a graphical illustration of a cross-sectional view of an array capacitor for decoupling multiple voltages, in accordance with one example embodiment of the invention. In accordance with the illustrated example embodiment, array capacitor 200 includes one or more of first capacitor region 202, second capacitor region 204, third capacitor region 206, bridge regions 208 and 210, top contacts 212, bottom contacts 214, vertical vias 216 and capacitor plates 218.

While shown as including three electrically isolated capacitor regions, array capacitor 200 may include any number of unique capacitor regions which may or may not have the same capacitance values. In one embodiment, capacitor regions 202 and 206 have capacitance values of about 2 microfarads, while capacitor region 204 has a capacitance value of about 40 microfarads. In another embodiment, capacitor regions 202 and 206 are designed to provide decoupling to an I/O source voltage, while capacitor region 204 is designed to provide decoupling to a core (or common collector) voltage.

Bridge regions 208 and 210 electrically isolate and reduce crosstalk between capacitor regions 202, 204, and 206. Bridge regions 208 and 210 can be made of ceramic or other dielectric material. One skilled in the art would appreciate that the unique capacitor regions shown in array capacitor 200 can provide decoupling for multiple voltages.

Top contacts 212 and bottom contacts 214 represent bumps or other conductive elements through which array capacitor 200 may be coupled with other components, for example a substrate. As shown, vertical vias 216 carry current from bottom contacts 214 to top contacts 212, while capacitor plates 218 store charge, for example if array capacitor 200 is to be embedded within a substrate.

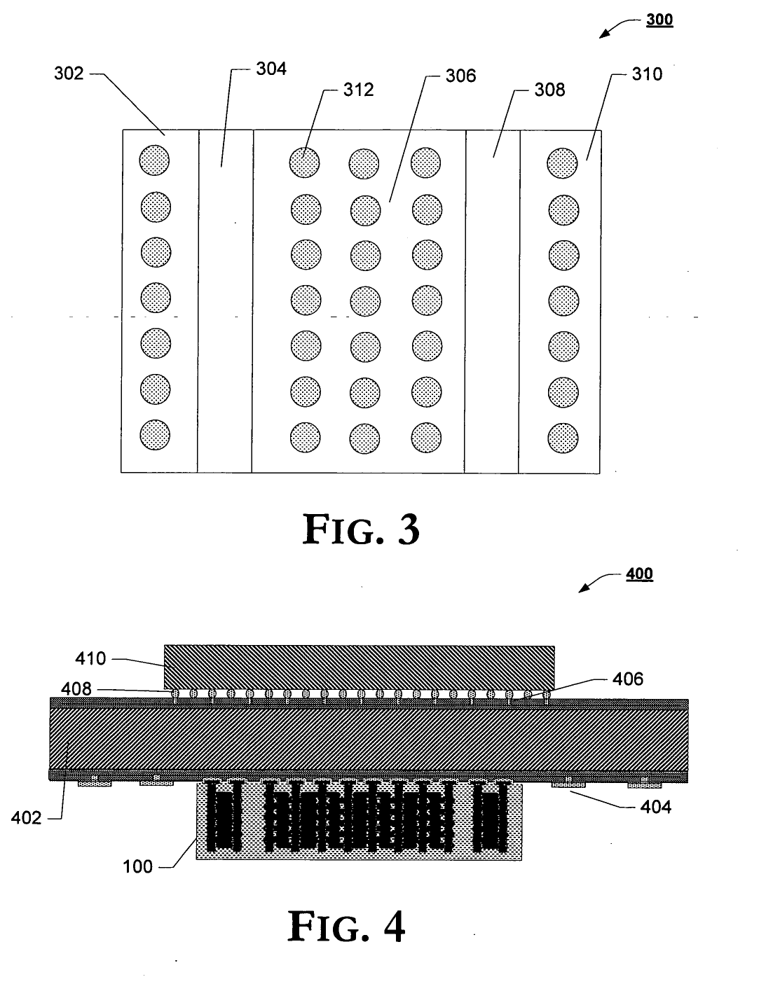

FIG. 3 is a graphical illustration of an overhead view of an array capacitor for decoupling multiple voltages, in accordance with one example embodiment of the invention. As shown, array capacitor 300 includes one or more of first capacitor region 302, bridge region 304, second capacitor region 306, bridge region 308, third capacitor region 310, and bumps 312. While shown as being square in shape, array capacitor 300 may encompass any shape without deviating from the scope of the present invention. Also, while shown as including three capacitor regions (302, 306, and 310) array capacitor 300 may include any number of capacitor regions for decoupling power. In one embodiment, array capacitor 300 is about 1 square centimeter in size. In one embodiment, bridge regions 304 and 308 have a thickness of about 100 micrometers.

FIG. 4 is a graphical illustration of a cross-sectional view of an IC package including an attached array capacitor for decoupling multiple voltages, in accordance with one example embodiment of the invention. As shown, IC package 400 includes one or more of array capacitor 100, dielectric layers 402, package connections 404, micro-vias 406, die bumps 408 and die 410. While shown with a single array capacitor 100, IC package 400 may include more than one array capacitor.

Dielectric layers 402 represent organic dielectric material, such as epoxy based dielectric, that has been added to a substrate as part of a build-up process. Metal traces, not shown, may be included in dielectric layers 402 to route signals to and from die 410.

Package connections 404 provide an interface between IC package 400 and other components, for example through a socket. In one embodiment, signals are routed through package connections 404 to traces in dielectric layers 402 while power and ground are routed through package connections 404 to contacts on the surface of array capacitor 100.

Micro-vias 406 may be formed on top of dielectric layers 402 as part of a manufacturing process to route the signal traces in dielectric layers 402 to the top of the package substrate.

Die bumps 408 may provide the mechanical and electrical connection between micro-vias 406 and die 410.

Die 410 may represent any type of integrated circuit device or devices that may benefit from the use of an array capacitor for decoupling multiple voltages, for example a multi-core processor.

FIG. 5 is a graphical illustration of a cross-sectional view of an IC package including an embedded array capacitor for decoupling multiple voltages, in accordance with one example embodiment of the invention. As shown, IC package 500 includes one or more of array capacitor 200, dielectric layers 502, package connections 504, micro-vias 506, die bumps 508 and die 510. While shown with a single array capacitor 200, IC package 500 may include more than one array capacitor.

Dielectric layers 502 represent organic dielectric material, such as epoxy based dielectric, that has been added to a substrate as part of a build-up process. Metal traces, not shown, may be included in dielectric layers 502 to route signals to and from die 510. To accommodate array capacitor 200, a portion of dielectric layers 502 may be removed, by etching or drilling for example, to expose micro-vias, or conductive elements coupled with package connections 504.

Package connections 504 provide an interface between IC package 500 and other components, for example through a socket. In one embodiment, signals are routed through package connections 504 to traces in dielectric layers 502 while power and ground are routed through package connections 504 to contacts on the bottom surface of array capacitor 200.

Micro-vias 506 may be formed on top of contacts on the top surface of array capacitor 200 as part of a manufacturing process to route the vertical vias in array capacitor 200 to the top of the package substrate.

Die bumps 508 may provide the mechanical and electrical connection between micro-vias 506 and die 510.

Die 510 may represent any type of integrated circuit device or devices that may benefit from the use of an array capacitor for decoupling multiple voltages, for example a multi-core processor.

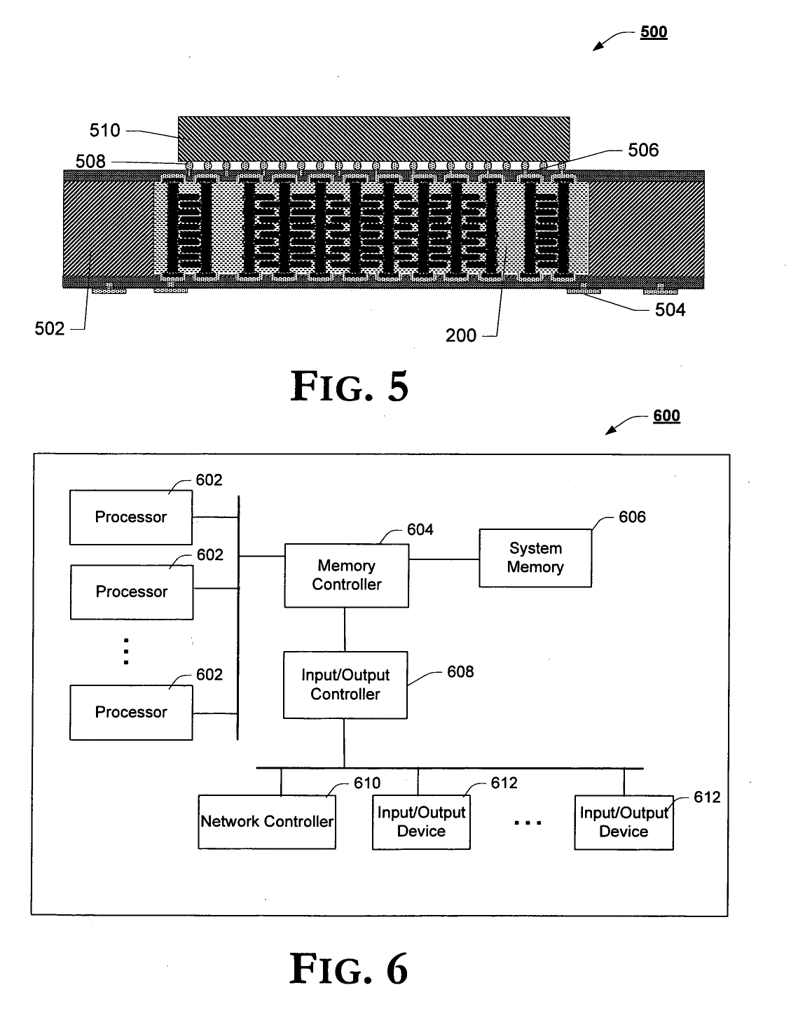

FIG. 6 is a block diagram of an example electronic appliance suitable for implementing an IC package including an array capacitor for decoupling multiple voltages, in accordance with one example embodiment of the invention. Electronic appliance 600 is intended to represent any of a wide variety of traditional and non-traditional electronic appliances, laptops, desktops, cell phones, wireless communication subscriber units, wireless communication telephony infrastructure elements, personal digital assistants, set-top boxes, or any electric appliance that would benefit from the teachings of the present invention. In accordance with the illustrated example embodiment, electronic appliance 600 may include one or more of processor(s) 602, memory controller 604, system memory 606, input/output controller 608, network controller 610, and input/output device(s) 612 coupled as shown in FIG. 6. Processor(s) 602, or other integrated circuit components of electronic appliance 600, may be housed in a package including a substrate with an attached or embedded array capacitor for decoupling multiple voltages described previously as an embodiment of the present invention.

Processor(s) 602 may represent any of a wide variety of control logic including, but not limited to one or more of a microprocessor, a programmable logic device (PLD), programmable logic array (PLA), application specific integrated circuit (ASIC), a microcontroller, and the like, although the present invention is not limited in this respect. In one embodiment, processors(s) 602 are Intel® processors. Processor(s) 602 may have an instruction set containing a plurality of machine level instructions that may be invoked, for example by an application or operating system.

Memory controller 604 may represent any type of chipset or control logic that interfaces system memory 606 with the other components of electronic appliance 600. In one embodiment, the connection between processor(s) 602 and memory controller 604 may be referred to as a front-side bus. In another embodiment, memory controller 604 may be referred to as a north bridge.

System memory 606 may represent any type of memory device(s) used to store data and instructions that may have been or will be used by processor(s) 602. Typically, though the invention is not limited in this respect, system memory 606 will consist of dynamic random access memory (DRAM). In one embodiment, system memory 606 may consist of Rambus DRAM (RDRAM). In another embodiment, system memory 606 may consist of double data rate synchronous DRAM (DDRSDRAM).

Input/output (I/O) controller 608 may represent any type of chipset or control logic that interfaces I/O device(s) 612 with the other components of electronic appliance 600. In one embodiment, I/O controller 608 may be referred to as a south bridge. In another embodiment, I/O controller 608 may comply with the Peripheral Component Interconnect (PCI) Express™ Base Specification, Revision 1.0a, PCI Special Interest Group, released Apr. 15, 2003.

Network controller 610 may represent any type of device that allows electronic appliance 600 to communicate with other electronic appliances or devices. In one embodiment, network controller 610 may comply with a The Institute of Electrical and Electronics Engineers, Inc. (IEEE) 802.11b standard (approved Sep. 16, 1999, supplement to ANSI/IEEE Std 802.11, 1999 Edition). In another embodiment, network controller 610 may be an Ethernet network interface card.

Input/output (I/O) device(s) 612 may represent any type of device, peripheral or component that provides input to or processes output from electronic appliance 600.

In the description above, for the purposes of explanation, numerous specific details are set forth in order to provide a thorough understanding of the present invention. It will be apparent, however, to one skilled in the art that the present invention may be practiced without some of these specific details. In other instances, well-known structures and devices are shown in block diagram form.

Many of the methods are described in their most basic form but operations can be added to or deleted from any of the methods and information can be added or subtracted from any of the described messages without departing from the basic scope of the present invention. Any number of variations of the inventive concept is anticipated within the scope and spirit of the present invention. In this regard, the particular illustrated example embodiments are not provided to limit the invention but merely to illustrate it. Thus, the scope of the present invention is not to be determined by the specific examples provided above but only by the plain language of the following claims.

What is claimed is:

1. An array capacitor tile comprising two electrically isolated capacitor regions.

2. The array capacitor of claim 1, wherein the capacitor regions provide different capacitance values.

3. The array capacitor of claim 1, wherein the array capacitor tile is about 1 square centimeter in size.

4. The array capacitor of claim 1, wherein the capacitor regions are electrically isolated by a ceramic bridge having a thickness of about 100 micrometers.

5. The array capacitor of claim 1, further comprising electrical connections on one side of the array capacitor which couple through to an opposite side of the array capacitor.

6. The array capacitor of claim 1, wherein one capacitor region is designed to provide decoupling for a core voltage while the other capacitor region is designed to provide decoupling for an I/O voltage.

7. The array capacitor of claim 1, further comprising one or more additional capacitor regions.

8. An apparatus comprising:
an integrated circuit die; and
a substrate, including an array capacitor with two or more electrically isolated capacitor regions.

9. The apparatus of claim 8, wherein the array capacitor is attached to a surface of the substrate.

10. The apparatus of claim 8, wherein the capacitor regions provide multiple capacitance values.

11. The apparatus of claim 8, wherein the capacitor regions are electrically isolated by a ceramic bridge having a thickness of about 100 micrometers.

12. An electronic appliance comprising:
a network controller;
a system memory; and
a processor, wherein the processor includes a substrate, including an array capacitor including two or more electrically isolated capacitor regions.

13. The electronic appliance of claim 12, wherein the array capacitor is coupled to a surface of the substrate.

14. The electronic appliance of claim 12, wherein the array capacitor is about 1 square centimeter in size.

15. The electronic appliance of claim 12, wherein the array capacitor includes electrical connections on only one side.
